(19) United States
(12) Patent Application Publication
(10) Pub. No.: US 2025/0353684 A1
(43) Pub. Date: Nov. 20, 2025

(54) PROCESSING APPARATUS

(71) Applicant: TOYOTA JIDOSHA KABUSHIKI KAISHA, Toyota-shi Aichi-ken (JP)

(72) Inventors: Shunta SHIMIZU, Edogawa-ku Tokyo-to (JP); Junya OTA, Edogawa-ku Tokyo-to (JP); Tatsuya TSUBAKIMOTO, Edogawa-ku Tokyo-to (JP)

(73) Assignee: TOYOTA JIDOSHA KABUSHIKI KAISHA, Toyota-shi Aichi-ken (JP)

(21) Appl. No.: 19/204,705

(22) Filed: May 12, 2025

(30) Foreign Application Priority Data
May 15, 2024 (JP) 2024-079354

(51) Int. Cl. B65G 1/137

(52) U.S. Cl. CPC B65G 1/1371; B65G 2203/0216; B65G 2203/0283; B65G 2209/04

(57) ABSTRACT

A processing apparatus capable of managing whether a usage state of a tray is a collection state or a delivery state is provided. A processing apparatus includes: a first acquisition unit that acquires latest usage state information including collection and delivery information of the tray; a second acquisition unit that acquires position information of the tray; a third acquisition unit that acquires identification information of the tray which is read by a reading unit provided for each of support units in the shelf and stored in a tag provided in the tray; and an update unit that updates the usage state information of the tray and the position information of the tray associated with the identification information of the tray based on the latest usage state information of the tray, the position information of the tray, and the identification information of the tray.

### CROSS REFERENCE TO RELATED APPLICATIONS

This application is based upon and claims the benefit of priority from Japanese patent application No. 2024-79354, filed on May 15, 2024, the disclosure of which is incorporated herein in its entirety by reference.

### BACKGROUND

The present disclosure relates to a processing apparatus.

For example, Patent Literature 1 discloses a management system capable of managing, by associating identification information of a tray with identification information of a package (i.e., an object to be collected and/or delivered) placed on the tray, a position and a delivery state of the tray including the package based on identification information of the tray.
[Patent Literature 1] Japanese Unexamined Patent Application Publication No. 2023-7473

### SUMMARY

The applicant has found the following problem. The management system disclosed in Patent Literature 1 can manage that the tray or the like is in a delivery state based on the identification information of the tray, but when the tray is also used at the time of collection, it cannot manage whether the usage state of the tray is a collection state or a delivery state.

The present disclosure has been made in order to solve the above-described problem and provides a processing apparatus capable of managing whether a usage state of a tray is a collection state or a delivery state.

A processing apparatus according to one aspect of the present disclosure is a processing apparatus used for collecting a package from a shelf and delivering a package to the shelf by using a tray, the processing apparatus including:
a first acquisition unit configured to acquire latest usage state information of the tray including collection and delivery information of the tray;
a second acquisition unit configured to acquire position information of the tray;
a third acquisition unit configured to acquire identification information of the tray which is read by a reading unit provided for each of support units capable of supporting the tray in the shelf and stored in a tag provided in the tray; and
an update unit configured to update the usage state information of the tray and the position information of the tray associated with the identification information of the tray based on the latest usage state information of the tray, the position information of the tray, and the identification information of the tray.

According to the present disclosure, it is possible to provide a processing apparatus capable of managing whether a usage state of a tray is a collection state or a delivery state.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a control system of a collection and delivery system according to a first embodiment;

FIG. 2 is a diagram showing a state in which a package is collected and delivered between a first collection and delivery shelf and a second collection and delivery shelf in the collection and delivery system according to the first embodiment;

FIG. 3 is a flowchart for explaining a flow in which a package is delivered using the collection and delivery system according to the first embodiment;

FIG. 4 is a flowchart for explaining a flow in which a package is collected using the collection and delivery system according to the first embodiment;

FIG. 5 is a block diagram showing a configuration of a control system of a collection and delivery system according to a second embodiment; and

FIG. 6 is a block diagram showing a configuration of a control system of a collection and delivery system according to a third embodiment.

### DESCRIPTION OF EMBODIMENTS

Specific embodiments to which the present disclosure is applied will be described hereinafter in detail with reference to the drawings. However, the present disclosure is not limited to the following embodiments. Further, the following descriptions and drawings are simplified as appropriate.

### First Embodiment

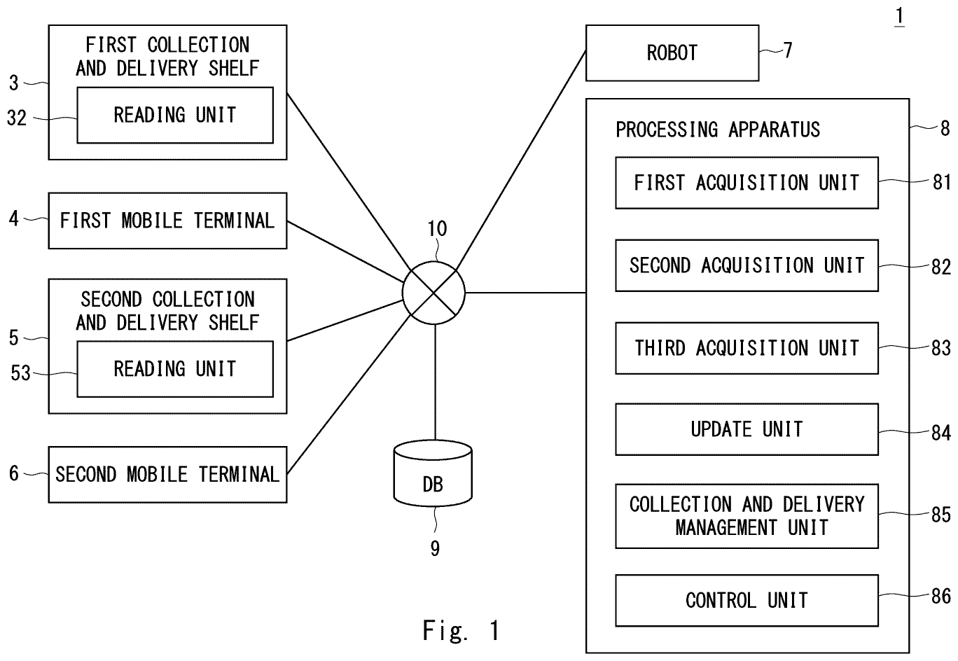

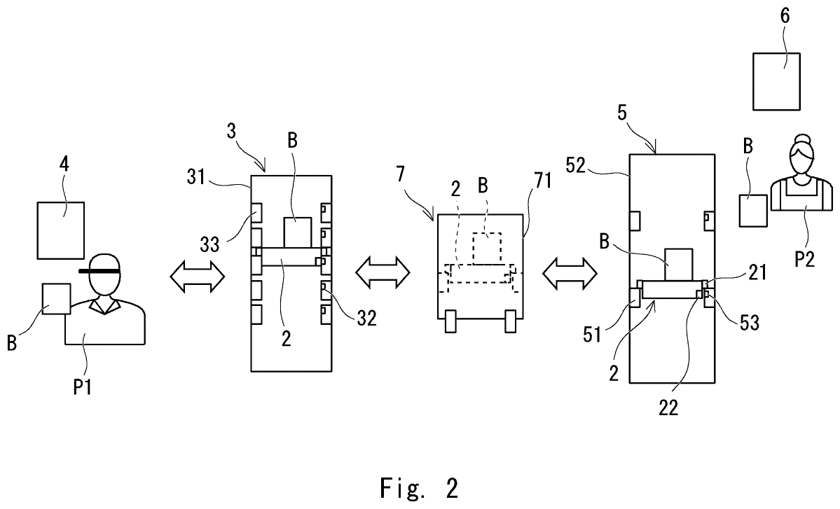

A collection and delivery system according to this embodiment is suitable for delivering a package placed on a tray from a first collection and delivery shelf to a second collection and delivery shelf, and collecting a package placed on a tray from the second collection and delivery shelf to the first collection and delivery shelf. FIG. 1 is a block diagram showing a configuration of a control system of a collection and delivery system according to this embodiment. FIG. 2 is a diagram showing a state in which a package is collected and delivered between a first collection and delivery shelf and a second collection and delivery shelf in the collection and delivery system according to this embodiment. Here, the “collection and delivery” means, for example, delivering a package or collecting a package.

As shown in FIGS. 1 and 2, a collection and delivery system 1 according to this embodiment includes a tray 2, a first collection and delivery shelf 3, a first mobile terminal 4, a second collection and delivery shelf 5, a second mobile terminal 6, a robot 7, a processing apparatus 8, and a database (DB) 9. The first collection and delivery shelf 3, the first mobile terminal 4, the second collection and delivery shelf 5, the second mobile terminal 6, the robot 7, processing apparatus 8, and the DB 9 mentioned above are connected through a network 10. The network 10 is a wired or wireless communication line, for example, the Internet.

As shown in FIG. 2, the tray 2 has, for example, a flat plate shape on which a package B can be placed as its basic form, and a flange 21 protrudes on the side of the tray 2. A tag 22 storing identification information assigned to each tray 2 is provided on the side surface of the tray 2. The tag 22 may be, for example, an NFC (Near Field Communication) tag whose identification information can be read by a reading apparatus. The tray 2 is repeatedly used to collect and deliver the package B, and is collected and delivered together with the package B.

The first collection and delivery shelf 3 is disposed at a collection and delivery base for temporarily storing, for example, packages for delivery and collected packages. As shown in FIG. 2, the first collection and delivery shelf 3 includes, for example, a frame 31 and a reading unit 32. The frame 31 has, for example, a substantially rectangular shape when the frame 31 is viewed from the front thereof as a basic form, and the front and rear surfaces of the frame 31 are opened. As shown in FIG. 2, a plurality of pairs of rails (support units) 33 are arranged on the inner surface of the frame 31 at intervals in the up-and-down direction of the frame 31. The pair of rails 33 extends in the front-rear direction of the frame 31, and supports the tray 2 by the flange 21 of the tray 2 being placed thereon. That is, the height position at which the tray 2 is supported can be changed by appropriately selecting one pair of rails 33 among a plurality of pairs of rails 33 and inserting the tray 2 into the selected pair of rails 33. The plurality of pairs of rails 33 are provided with identification information including height position information of the rails 33 for each pair of rails 33.

As shown in FIG. 2, the reading unit 32, for example, is fixed to the frame 31 for each pair of rails 33. The reading unit 32 recognizes that the tray 2 is inserted into the pair of rails 33 when the tag 22 of the tray 2 approaches within a predetermined range, thereby reading identification information of the tray 2 from the tag 22, and recognizes that the tray 2 is removed from the pair of rails 33 when the tag 22 of the tray 2 moves away from the predetermined range. The reading unit 32 has identification information of the first collection and delivery shelf 3 including position information thereof and identification information of the rails 33. The reading unit 32 associates the read identification information of the tray 2 with the identification information of the first collection and delivery shelf 3 and the identification information of the rails 33 supporting the tray 2 to the DB 9 and transmits the associated information. The reading unit 32 transmits insertion and removal information of the tray 2 to the DB 9.

The first mobile terminal 4 is, for example, a mobile terminal owned by a worker P1 who collects and delivers the package B at a collection and delivery base, and is used for reading the identification information of the tray 2 on which the package B is placed and associating it to the identification information of the package B when the worker P1 delivers the package B, or for inputting usage state information of the tray 2. Note that the identification information of the package B includes, for example, shipper information, name information, address information, and contact information of the delivery destination, and height information of the package B, and can be acquired by reading a unique two-dimensional code or the like shown on a slip attached to the package B by the first mobile terminal 4. The first mobile terminal 4 transmits the identification information of the tray 2 with which the identification information of the package B is associated, and the usage state information of the tray 2 to the DB 9.

The second collection and delivery shelf 5 is, for example, disposed at the residence of a requester P2 who wishes to receive the package B or that the package B will be collected. As shown in FIG. 2, for example, the second collection and delivery shelf 5 has a configuration substantially the same as that of the first collection and delivery shelf 3, and includes a frame 52 in which a plurality of pairs of rails 51 are arranged at intervals in the up-and-down direction, and a reading unit 53 disposed so that it can read the identification information of the tray 2 from the tag 22 of the tray 2 supported by the pair of rails 51. The reading unit 53 has identification information of the second collection and delivery shelf 5 including the position information thereof and identification information of the rails 51. The reading unit 53 associates the read identification information of the tray 2 with the identification information of the second collection and delivery shelf 5 and the identification information of the rails 51 supporting the tray 2 to the DB 9 and transmits the associated information. Further, the reading unit 53 transmits insertion and removal information of the tray 2 to the DB 9.

The second mobile terminal 6 is, for example, a mobile terminal owned by the requester P2, and used to read the identification information of the package B which the requester P2 has requested to be collected, to read the identification information of the tray 2 on which the package B which the requester P2 has requested to be collected is placed and then associate it with the identification information of the package B, and to input receipt request information of the package B and collection and delivery request information of the package B. The second mobile terminal 6 transmits the identification information of the tray 2 with which the identification information of the package B is associated, the receipt request information of the package B, and the collection and delivery request information of the package B to the DB 9. Here, the second mobile terminal 6 can also acquire the identification information of the package B by reading a unique two-dimensional code or the like shown on a slip attached to the package B.

The robot 7 is a mobile body for collecting and delivering the tray 2 between the first collection and delivery shelf 3 and the second collection and delivery shelf 5. As shown in FIG. 2, the robot 7 includes, for example, a housing part 71, and is configured to be able to house the tray 2 from the housing part 71 to the first collection and delivery shelf 3 or the second collection and delivery shelf 5, or to collect the tray 2 from the first collection and delivery shelf 3 or the second collection and delivery shelf 5 to the housing part 71 by a conveyance mechanism (not shown). The robot 7 is configured to be able to acquire position information of the robot 7 by GPS (Global Positioning System) or the like. The robot 7 transmits position information of the robot 7 to the DB 9.

As shown in FIG. 1, the processing apparatus 8 includes a first acquisition unit 81, a second acquisition unit 82, a third acquisition unit 83, an update unit 84, a collection and delivery management unit 85, and a control unit 86. The first acquisition unit 81 acquires the latest usage state information of the tray 2. The usage state information of the tray 2 is information indicating, for example, whether the tray 2 is used for collection of the package B or the tray 2 is used for delivery of the package B. The first acquisition unit 81 acquires the latest usage state information of the tray 2 based on the usage state information of the tray 2 transmitted from the first mobile terminal 4 or the second mobile terminal 6.

The second acquisition unit 82 acquires position information of the tray 2. The position information of the tray 2 is, for example, position information of the first collection and delivery shelf 3 housing the tray 2 and height position information of the rails 33, position information of the tray 2 being moved by the robot 7, or position information of the second collection and delivery shelf 5 housing the tray 2 and height position information of the rails 51. The second acquisition unit 82 acquires the position information of the first collection and delivery shelf 3 housing the tray 2 and the height position information of the rails 33 based on the identification information of the first collection and delivery shelf 3 and the identification information of the rails 33 supporting the tray 2 transmitted from the reading unit 32 of the first collection and delivery shelf 3. The second acquisition unit 82 acquires the position information of the tray 2 being moved by the robot 7 based on the insertion and removal information of the tray 2 and the position information of the robot 7 transmitted from the reading unit 32 of the first collection and delivery shelf 3 or the reading unit 53 of the second collection and delivery shelf 5. The second acquisition unit 82 acquires the position information of the second collection and delivery shelf 5 housing the tray 2 and the height position information of the rails 51 based on the identification information of the second collection and delivery shelf 5 and the identification information of the rails 51 supporting the tray 2 transmitted from the reading unit 53 of the second collection and delivery shelf 5.

The third acquisition unit 83 acquires the identification information of the tray 2 transmitted from the reading unit 32 of the first collection and delivery shelf 3 or the reading unit 53 of the second collection and delivery shelf 5. The update unit 84 updates the usage state information of the tray 2 and the position information of the tray 2 associated with the identification information of the tray 2 based on the position information of the tray 2, the latest usage state information of the tray 2, and the identification information of the tray 2. The collection and delivery management unit 85 generates instruction information for instructing the worker P1 to prepare for collection and delivery of the package B and generates control information for controlling the robot 7 to collect and deliver the package B. Specifically, the collection and delivery management unit 85 generates instruction information for instructing the worker P1 to prepare for delivery of the package B based on the receipt request information of the package B transmitted from the second mobile terminal 6. Further, the collection and delivery management unit 85 generates instruction information for instructing the worker P1 to prepare the tray 2 for collecting and delivering the package B based on the collection and delivery request information of the package B transmitted from the second mobile terminal 6. Furthermore, the collection and delivery management unit 85 generates control information for controlling the robot 7 based on the usage state information of the tray 2, the identification information of the first collection and delivery shelf 3, the identification information of the rails 33 supporting the tray 2, the identification information of the second collection and delivery shelf 5, and the identification information of the rails 51 supporting the tray 2. The control unit 86 controls the robot 7 on the basis of the control information generated by the collection and delivery management unit 85. The DB 9 stores the identification information of the first collection and delivery shelf 3, the identification information of the rails 33 supporting the tray 2, the identification information of the second collection and delivery shelf 5, the identification information of the rails 51 supporting the tray 2, the identification information of the tray 2, the usage state information of the tray 2, the position information of the tray 2, the insertion and removal information of the tray 2, the identification information of the package B, and the position information of the robot 7, and the like.

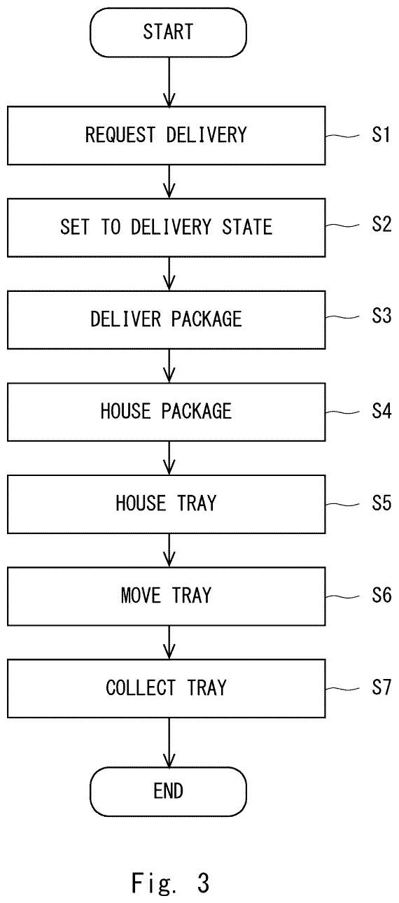

Next, a flow in which the package B is delivered using the collection and delivery system 1 according to this embodiment will be described. FIG. 3 is a flowchart for explaining a flow in which a package is delivered using the collection and delivery system according to this embodiment. First, when the requester P2 inputs receipt request information of the package B through the second mobile terminal 6, the second mobile terminal 6 transmits the receipt request information of the package B to the processing apparatus 8 (S1). The collection and delivery management unit 85 of the processing apparatus 8 specifies the package to be delivered to the requester P2 based on identification information of the package B, generates instruction information for making the worker P1 prepare to deliver the specified package B, and transmits it to the first mobile terminal 4. At this time, the worker P1 registers the identification information of the package B in the DB 9 in advance. Note that when the requester P2 does not input the receipt request information of the package B, the package B may be delivered to the second collection and delivery shelf 5 for reasons such as the operating states of the worker P1 and the robot 7.

The worker P1 prepares the package B to be delivered based on the instruction information and the tray 2 on which the package B is to be placed, reads the identification information of the package B and identification information of the tray 2 through the first mobile terminal 4, sets usage state information of the tray 2 to a delivery state, and inserts the tray 2 on which the package B is placed into the rails 33 of the first collection and delivery shelf 3 to make them support the tray 2 (S2). The first mobile terminal 4 transmits the usage state information of the tray 2 and the identification information of the tray 2 with which the identification information of the package B is associated to the processing apparatus 8. Thus, for example, based on the usage state information of the tray 2 and the identification information of the tray 2, the update unit 84 of the processing apparatus 8 updates the usage state of the tray 2 to a delivery state when the usage state of the tray 2 is a collection state. The reading unit 32 of the first collection and delivery shelf 3 reads the identification information of the tray 2 and transmits the identification information of the tray 2, insertion and removal information of the tray 2, identification information of the first collection and delivery shelf 3, and identification information of the rails 33 by which the tray 2 is supported to the processing apparatus 8. Thus, the identification information of the tray 2 is associated with the usage state information of the tray 2, the identification information of the package B, the identification information of the first collection and delivery shelf 3, and the identification information of the rails 33 by which the tray 2 is supported, and the update unit 84 of the processing apparatus 8 can recognize that the usage state of the tray 2 is a delivery state and the tray 2 is in a moving standby state at the first collection and delivery shelf 3 to deliver the package B. Further, the collection and delivery management unit 85 of the processing apparatus 8 can recognize the usage state of the rails 33 of the first collection and delivery shelf 3 based on the insertion and removal information of the tray 2.

Next, the collection and delivery management unit 85 of the processing apparatus 8 specifies the second collection and delivery shelf 5 from which the requester P2 receives the package B based on the identification information of the package B, and generates control information for robot 7 to deliver the package B from the first collection and delivery shelf 3 to the second collection and delivery shelf 5 based on identification information of the specified second collection and delivery shelf 5, the usage state information of the tray 2 associated with the identification information of the tray 2, the identification information of the first collection and delivery shelf 3, and the identification information of the rails 33 by which the tray 2 is supported. At this time, the collection and delivery management unit 85 of the processing apparatus 8 may generate control information such that, based on usage state information of the rails 51 of the second collection and delivery shelf 5 and height information included in the identification information of the package B, the rails 51 into which the tray 2 can be inserted together with the package B in the second collection and delivery shelf 5 is derived and the tray 2 is inserted into the derived rails 51.

Next, the robot 7 operates based on the control information to remove the tray 2 on which the package B is placed from the first collection and delivery shelf 3 and delivers it to the second collection and delivery shelf 5 (S3). The reading unit 32 of the first collection and delivery shelf 3 transmits the insertion and removal information of the tray 2 to the processing apparatus 8. Thus, the update unit 84 of the processing apparatus 8 can recognize that the usage state of the tray 2 is a delivery state and the tray 2 is moving to the second collection and delivery shelf 5, and can acquire position information of the tray 2 based on position information of the robot 7. Further, the collection and delivery management unit 85 of the processing apparatus 8 can recognize the usage state of the rails 33 of the first collection and delivery shelf 3.

Then, the robot 7 inserts the tray 2 on which the package B is placed into the rails 51 of the second collection and delivery shelf 5 to make them support the tray 2, and houses the package B in the second collection and delivery shelf 5 (S4). The reading unit 53 of the second collection and delivery shelf 5 reads the identification information of the tray 2, and transmits the identification information of the tray 2, the insertion and removal information of the tray 2, the identification information of the second collection and delivery shelf 5, and the identification information of the rails 51 by which the tray 2 is supported to the processing apparatus 8. Thus, the update unit 84 of the processing apparatus 8 can recognize that the usage state of the tray 2 is a delivery state and the package B is in a receiving standby state at the second collection and delivery shelf 5. Further, the collection and delivery management unit 85 of the processing apparatus 8 can recognize the usage state of the rails 51 of the second collection and delivery shelf 5 based on the insertion and removal information of the tray 2. At this time, the collection and delivery management unit 85 of the processing apparatus 8 may generate delivery completion information indicating that the package B has been delivered to the second collection and delivery shelf 5, and transmit it to the second mobile terminal 6. Thus, the requester P2 can recognize that the package B has arrived at the second collection and delivery shelf 5.

The requester P2 receives the package B by removing the tray 2 from the second collection and delivery shelf 5, then inserts the tray 2 into the rails 51 of the second collection and delivery shelf 5 to make them support the tray 2, and houses the tray 2 in the second collection and delivery shelf 5 (S5). The reading unit 53 of the second collection and delivery shelf 5 reads the identification information of the tray 2, and transmits the identification information of the tray 2, the insertion and removal information of the tray 2, the identification information of the second collection and delivery shelf 5, and the identification information of the rails 51 by which the tray 2 is supported to the processing apparatus 8. As a result, the update unit 84 of the processing apparatus 8 can recognize that the delivery of the package B has been completed and that the usage state of the tray 2 is a delivery state and the tray 2 is in a collection standby state at the second collection and delivery shelf 5. Further, the collection and delivery management unit 85 of the processing apparatus 8 can recognize the usage state of the rails 51 of the second collection and delivery shelf 5 based on the insertion and removal information of the tray 2. Note that if the insertion and removal information of the tray 2 can be updated, the requester P2 does not need to completely remove the tray 2 from the second collection and delivery shelf 5.

After that, the collection and delivery management unit 85 of the processing apparatus 8 generates control information for the robot 7 to collect the tray 2 from the second collection and delivery shelf 5 and house it in the first collection and delivery shelf 3 based on the usage state information of the tray 2, the identification information of the first collection and delivery shelf 3, the identification information of the second collection and delivery shelf 5, and the identification information of the rails 51 by which the tray 2 is supported. At this time, the collection and delivery management unit 85 of the processing apparatus 8 may generate control information such that, based on the usage state information of the rails 33 of the first collection and delivery shelf 3, the rails 33 into which the tray 2 can be inserted in the first collection and delivery shelf 3 are derived and the tray 2 is inserted into the derived rails 33.

The robot 7 operates based on the control information, removes and collects the tray 2 from the second collection and delivery shelf 5, and moves it to the first collection and delivery shelf 3 (S6). The reading unit 53 of the second collection and delivery shelf 5 transmits the insertion and removal information of the tray 2 to the processing apparatus 8. Thus, the update unit 84 of the processing apparatus 8 can recognize that the usage state of the tray 2 is a delivery state and the tray 2 is moving to the first collection and delivery shelf 3, and can acquire position information of the tray 2 based on the position information of the robot 7. Further, the collection and delivery management unit 85 of the processing apparatus 8 can recognize the usage state of the rails 51 of the second collection and delivery shelf 5.

Then, the robot 7 inserts the tray 2 into the rails 33 of the first collection and delivery shelf 3 to make them support the tray 2, and houses the tray 2 in the first collection and delivery shelf 3 (S7). The reading unit 32 of the first collection and delivery shelf 3 reads the identification information of the tray 2, and transmits the identification information of the tray 2, the insertion and removal information of the tray 2, the identification information of the first collection and delivery shelf 3, and the identification information of the rails 33 of the first collection and delivery shelf 3 to the processing apparatus 8. Thus, the update unit 84 of the processing apparatus 8 can recognize that the usage state of the tray 2 is a delivery state and the tray 2 is in a collection completion state in which the tray 2 has been collected and housed in the first collection and delivery shelf 3. Further, the collection and delivery management unit 85 of the processing apparatus 8 can recognize the usage state of the rails 33 of the first collection and delivery shelf 3.

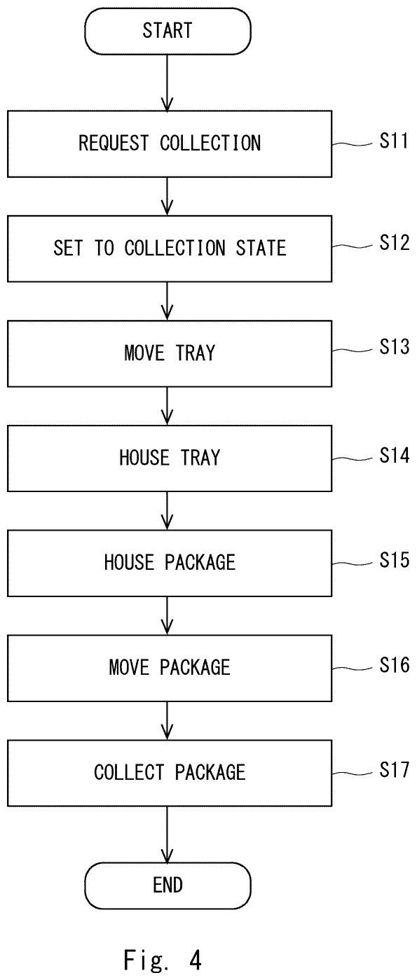

Next, a flow in which the package B is collected using the collection and delivery system 1 according to this embodiment will be described. FIG. 4 is a flowchart for explaining a flow in which a package is collected using the collection and delivery system according to this embodiment. First, when the requester P2 registers identification information of the package B which the requester P2 wishes to collect through the second mobile terminal 6 or reads identification information of the package B and inputs collection request information of the package B, the second mobile terminal 6 transmits the identification information of the package B and the collection request information of the package B to the processing apparatus 8 (S11).

The collection and delivery management unit 85 of the processing apparatus 8 generates instruction information for making the worker P1 prepare the tray 2 for collecting the package B and transmits it to the first mobile terminal 4. The worker P1 prepares the tray 2 for collecting the package B, reads identification information of the tray 2 through the first mobile terminal 4, sets usage state information of the tray 2 to a collection state, and inserts the tray 2 into the rails 33 of the first collection and delivery shelf 3 to make them support the tray 2 (S12). However, the requester P2 may use the tray 2, which is in a collection standby state in the second collection and delivery shelf 5, and set the usage state information of the tray 2 to a collection state. In this case, the tray 2 which has already been inserted into the second collection and delivery shelf 5 and supported may be used.

The first mobile terminal 4 transmits the identification information of the tray 2 associated with the usage state information of the tray 2 and identification information of the package B to the processing apparatus 8. Thus, for example, based on the usage state information of the tray 2 and the identification information of the tray 2, the update unit 84 of the processing apparatus 8 updates the usage state of the tray 2 to a collection state when the usage state of the tray 2 is a delivery state. Then, the reading unit 32 of the first collection and delivery shelf 3 reads the identification information of the tray 2, and transmits the identification information of the tray 2, insertion and removal information of the tray 2, identification information of the first collection and delivery shelf 3, and identification information of the rails 33 supporting the tray 2 to the processing apparatus 8. Thus, the identification information of the tray 2 is associated with the usage state information of the tray 2, the identification information of the package B, the identification information of the first collection and delivery shelf 3, and the identification information of the rails 33 supporting the tray 2, and the update unit 84 of the processing apparatus 8 can recognize that the usage state of the tray 2 is a collection state and the tray 2 is in a moving standby state for collecting the package B at the first collection and delivery shelf 3. Further, the collection and delivery management unit 85 of the processing apparatus 8 can recognize the usage state of the rails 33 of the first collection and delivery shelf 3 based on the insertion and removal information of the tray 2.

Next, the collection and delivery management unit 85 of the processing apparatus 8 specifies the second collection and delivery shelf 5 from which the requester P2 receives the package B based the identification information of the package B, and generates control information for the robot 7 to move the tray 2 from the first collection and delivery shelf 3 to the second collection and delivery shelf 5 based on the usage state information of the tray 2, identification information of the specified second collection and delivery shelf 5, the identification information of the first collection and delivery shelf 3, and the identification information of rails 33 supporting the tray 2. At this time, the collection and delivery management unit 85 of the processing apparatus 8 may generate control information such that, based on the usage state information of the rails 51 of the second collection and delivery shelf 5, the rails 51 into which the tray 2 can be inserted in the second collection and delivery shelf 5 are derived and the tray 2 is inserted into the derived rails 51.

Next, the robot 7 operates based on the control information to remove the tray 2 from the first collection and delivery shelf 3 and moves it to the second collection and delivery shelf 5 (S13). At this time, the reading unit 32 of the first collection and delivery shelf 3 transmits the insertion and removal information of the tray 2 to the processing apparatus 8. Thus, the update unit 84 of the processing apparatus 8 can recognize that the usage state of the tray 2 is a collection state and the tray 2 is moving to the second collection and delivery shelf 5, and can acquire position information of the tray 2 based on position information of the robot 7. Further, the collection and delivery management unit 85 of the processing apparatus 8 can recognize the usage state of the rails 33 of the first collection and delivery shelf 3.

Then, the robot 7 inserts the tray 2 into the rails 51 of the second collection and delivery shelf 5 to make them support the tray 2, and houses the tray 2 in the second collection and delivery shelf 5 (S14). The reading unit 53 of the second collection and delivery shelf 5 reads the identification information of the tray 2, and transmits the identification information of the tray 2, the insertion and removal information of the tray 2, the identification information of the second collection and delivery shelf 5, and the identification information of the rails 51 supporting the tray 2 the processing apparatus 8. Thus, the update unit 84 of the processing apparatus 8 can recognize that the usage state of the tray 2 is a collection state and the tray 2 is in a collection standby state for collecting the package B at the second collection and delivery shelf 5. Further, the collection and delivery management unit 85 of the processing apparatus 8 can recognize the usage state of the rails 51 of the second collection and delivery shelf 5. At this time, the collection and delivery management unit 85 of the processing apparatus 8 may generate collection preparation completion information indicating that the tray 2 has been delivered to the second collection and delivery shelf 5, and transmit it to the second mobile terminal 6. Thus, the requester P2 can recognize that the tray 2 for collecting the package B has arrived at the second collection and delivery shelf 5.

Then, the requester P2 removes the tray 2 from the second collection and delivery shelf 5, reads the identification information of the tray 2 and the identification information of the package B through the second mobile terminal 6, inserts the tray 2 on which the package B is placed into the rails 51 of the second collection and delivery shelf 5 to make them support the tray 2, and houses the tray 2 in the second collection and delivery shelf 5 (S15). The reading unit 53 of the second collection and delivery shelf 5 reads the identification information of the tray 2, and transmits the identification information of the tray 2, the insertion and removal information of the tray 2, the identification information of the second collection and delivery shelf 5, and the identification information of the rails 51 supporting the tray 2 to the processing apparatus 8. As a result, the update unit 84 of the processing apparatus 8 can recognize that the usage state of the tray 2 is a collection state and the tray 2 on which the package B to be collected is placed is in a collection standby state at the second collection and delivery shelf 5. Further, the collection and delivery management unit 85 of the processing apparatus 8 can recognize the usage state of the rails 51 of the second collection and delivery shelf 5 based on the insertion and removal information of the tray 2.

After that, the collection and delivery management unit 85 of the processing apparatus 8 generates control information for the robot 7 to collect the tray 2 on which the package B is placed from the second collection and delivery shelf 5 to the first collection and delivery shelf 3 based on the usage state information of the tray 2, the identification information of the first collection and delivery shelf 3, the identification information of the second collection and delivery shelf 5, and the identification information of the rails 51 by which the tray 2 is supported. At this time, the collection and delivery management unit 85 of the processing apparatus 8 may generate control information such that, based on usage state information of the rails 33 of the first collection and delivery shelf 3 and height information included in the identification information of the package B, the rails 33 into which the tray 2 can be inserted together with the package B in the first collection and delivery shelf 3 are derived, and the tray 2 is inserted into the derived rails 33.

The robot 7 operates based on the control information, removes and collects the tray 2 on which the package B is placed from the second collection and delivery shelf 5, and moves it to the first collection and delivery shelf 3 (S16). The reading unit 53 of the second collection and delivery shelf 5 transmits the insertion and removal information of the tray 2 to the processing apparatus 8. Thus, the update unit 84 of the processing apparatus 8 can recognize that the usage state of the tray 2 is a collection state and the tray 2 on which the package B is placed is moving to the first collection and delivery shelf 3, and can acquire position information of the tray 2 based on the position information of the robot 7. Further, the collection and delivery management unit 85 of the processing apparatus 8 can recognize the usage state of the rails 51 of the second collection and delivery shelf 5 based on the insertion and removal information of the tray 2.

Then, the robot 7 inserts the tray 2 on which the package B is placed into the rails 33 of the first collection and delivery shelf 3 to make them support the tray 2, and houses the tray 2 in the first collection and delivery shelf 3 (S17). The reading unit 32 of the first collection and delivery shelf 3 reads the identification information of the tray 2, and transmits the identification information of the tray 2, the insertion and removal information of the tray 2, the identification information of the first collection and delivery shelf 3, and the identification information of the rails 33 supporting the tray 2 to the processing apparatus 8. Thus, the update unit 84 of the processing apparatus 8 can recognize that the usage state of the tray 2 is a collection state and the tray 2 on which the package B is placed is in a collection completion state in which the tray 2 has been collected and housed in the first collection and delivery shelf 3. Further, the collection and delivery management unit 85 of the processing apparatus 8 can recognize the usage state of the rails 33 of the first collection and delivery shelf 3 based on the insertion and removal information of the tray 2.

As described above, the collection and delivery system 1 and the processing apparatus 8 according to this embodiment can acquire usage state information of the tray 2 input through the first mobile terminal 4 owned by the worker P1 and the second mobile terminal 6 owned by the requester P2, and can recognize whether the latest usage state of the tray 2 is a delivery state or a collection state. Therefore, the collection and delivery system 1 and the processing apparatus 8 according to this embodiment can easily manage whether the usage state of the tray 2 is a collection state or a delivery state.

### Second Embodiment

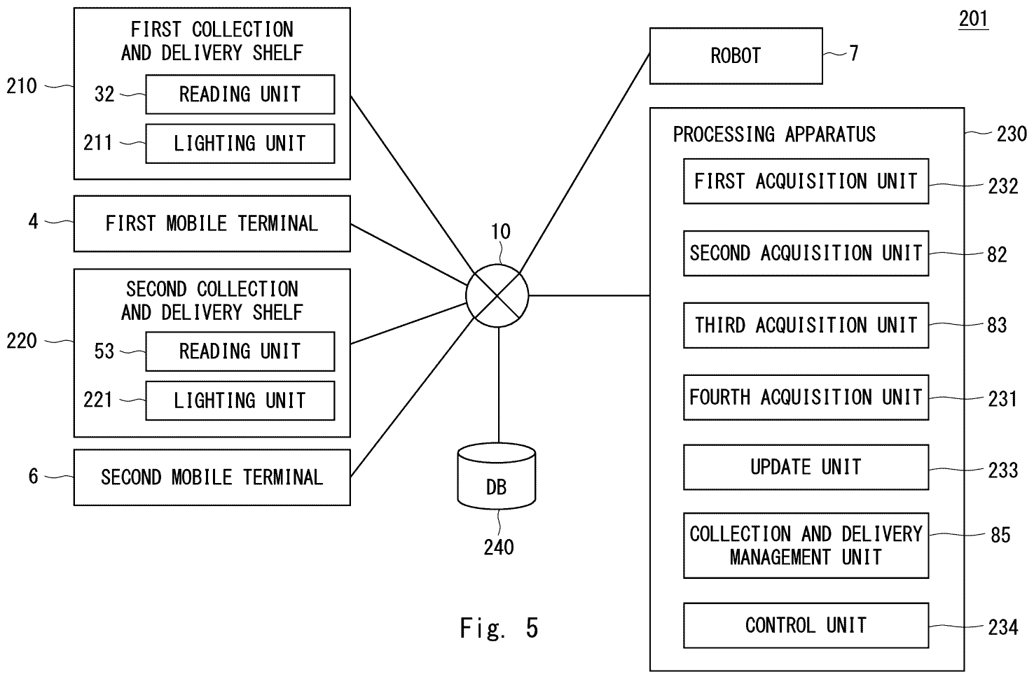

FIG. 5 is a block diagram showing a configuration of a control system of a collection and delivery system according to this embodiment. A collection and delivery system 201 according to this embodiment has a configuration substantially the same as that of the collection and delivery system 1 according to the first embodiment, but it is configured to be capable of updating the usage state of the tray 2 in accordance with usage modes set in a first collection and delivery shelf 210 and a second collection and delivery shelf 220. As shown in FIG. 5, a processing apparatus 230 has a configuration substantially the same as that of the processing apparatus 8 according to the first embodiment, but it includes a fourth acquisition unit 231 that acquires the usage modes set in the first collection and delivery shelf 210 and the second collection and delivery shelf 220.

For example, regarding the usage mode of the first collection and delivery shelf 210, the worker P1 may set it to either a delivery mode or a collection mode through the first mobile terminal 4. The fourth acquisition unit 231 of the processing apparatus 230, for example, associates information indicating the usage mode of the first collection and delivery shelf 210 with identification information of the first collection and delivery shelf 210, and stores it in a DB 240. In addition, for example, regarding the usage mode of the second collection and delivery shelf 220, the requester P2 may set in to either a delivery mode or a collection mode through the second mobile terminal 6. The fourth acquisition unit 231 of the processing apparatus 230, for example, associates information indicating the usage mode of the second collection and delivery shelf 220 with identification information of the second collection and delivery shelf 220, and stores it in the DB 240. Thus, when the worker P1 makes the rails 33 of the first collection and delivery shelf 210 support the tray 2 while the first collection and delivery shelf 210 is set to a delivery mode, or when the requester P2 makes the rails 51 of the second collection and delivery shelf 220 support the tray 2 while the second collection and delivery shelf 220 is set to a delivery mode, a first acquisition unit 232 of the processing apparatus 230 acquires the latest usage state indicating that the tray 2 is in a delivery state.

On the other hand, when the worker P1 makes the rails 33 of the first collection and delivery shelf 210 support the tray 2 while the first collection and delivery shelf 210 is set to a collection mode, or when the requester P2 makes the rails 51 of the second collection and delivery shelf 220 support the tray 2 while the second collection and delivery shelf 220 is set to a collection mode, the first acquisition unit 232 of the processing apparatus 230 acquires the latest usage state indicating that the tray 2 is in a collection state. Then, an update unit 233 of the processing apparatus 230 updates usage state information of the tray 2 based on the latest usage state information of the tray 2 acquired by the first acquisition unit 232. Note that the usage modes set in the first collection and delivery shelf 210 and the second collection and delivery shelf 220 may be reset after a predetermined time has elapsed.

By setting the usage mode of the first collection and delivery shelf 210 through the first mobile terminal 4 and the usage mode of the second collection and delivery shelf 220 through the second mobile terminal 6 in this way, the usage state information of the tray 2 can be easily acquired. At this time, a lighting unit 211 such as an LED (Light Emitting Diode) may be provided in the frame 31 of the first collection and delivery shelf 210 for each pair of the rails 33 of the first collection and delivery shelf 210. In addition, a lighting unit 221 such as an LED may be provided in the frame 52 of the second collection and delivery shelf 220 for each pair of the rails 51 of the second collection and delivery shelf 220. The lighting units 211 of the first collection and delivery shelf 210 and the lighting units 221 of the second collection and delivery shelf 220 are controlled by a control unit 234 of the processing apparatus 230.

Specifically, when the first collection and delivery shelf 210 is set to a delivery mode, the control unit 234 of the processing apparatus 230 turns on, based on the usage state information of the tray 2, the lighting units 211 of the rails 33 supporting the tray 2 after the delivered package B is received, and the lighting unit 211 of the rails 33 supporting the tray 2 on which the package B to be delivered is placed. Further, when the first collection and delivery shelf 210 is set to a collection mode, the control unit 234 of the processing apparatus 230 turns on, based on the usage state information of the tray 2, the lighting units 211 of the rails 33 supporting the tray 2 before the package B to be collected is placed, and the lighting unit 211 of the rails 33 supporting the tray 2 on which the package B to be collected is placed. Thus, the worker P1 can easily recognize, for example, whether the package B housed in the first collection and delivery shelf 210 is a package to be delivered or a collected package. Further, the worker P1 can easily recognize, for example, whether the tray 2 housed in the first collection and delivery shelf 210 is the tray 2 for collecting the package B or the tray 2 after delivering the package B.

When the second collection and delivery shelf 220 is set to a delivery mode, the control unit 234 of the processing apparatus 230 turns on, based on the usage state information of the tray 2, the lighting units 221 of the rails 51 supporting the tray 2 on which the package B to be delivered is placed, and the lighting unit 221 of the rails 51 supporting the tray 2 after the delivered package B is received. Further, when the second collection and delivery shelf 220 is set to a collection mode, the control unit 234 of the processing apparatus 230 turns on, based on the usage state information of the tray 2, the lighting units 221 of the rails 51 supporting the tray 2 before the package B to be collected is placed, and the lighting unit 221 of the rails 51 supporting the tray 2 on which the package B to be collected is placed. Thus, the requester P2 can easily recognize, for example, whether the package B housed in the second collection and delivery shelf 220 is a delivered package or a collected package. Further, the requester P2 can easily recognize, for example, whether the tray 2 housed in the second collection and delivery shelf 220 is the tray 2 for collecting the package B or the tray 2 after delivering the package B.

### Third Embodiment

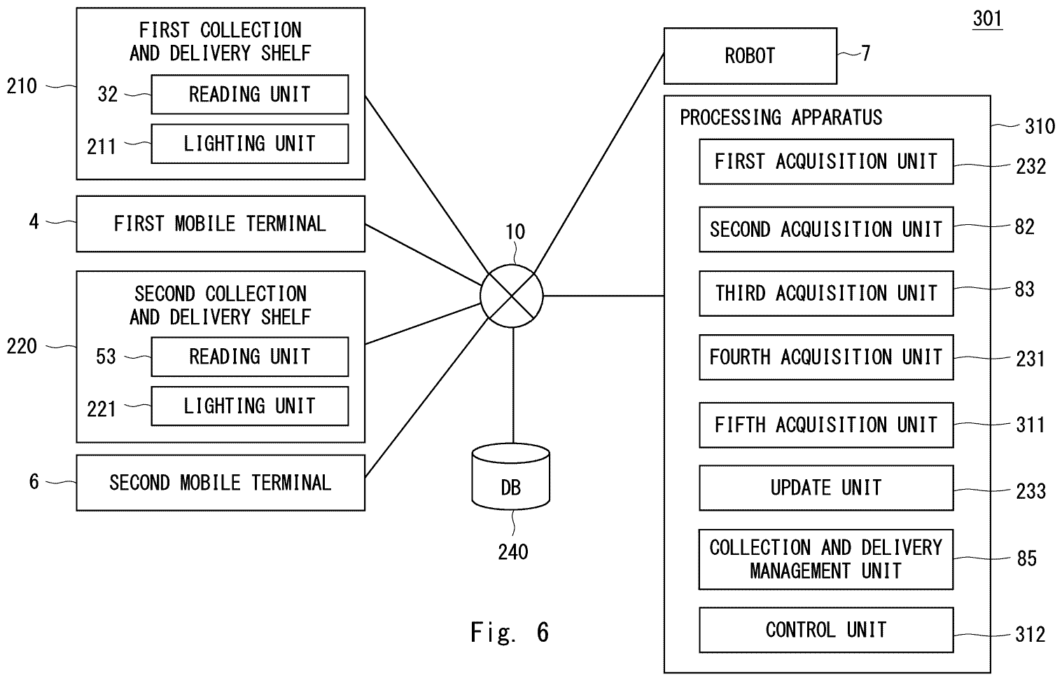

FIG. 6 is a block diagram showing a configuration of a control system of a collection and delivery system according to this embodiment. Since a collection and delivery system 301 according to this embodiment has a configuration substantially the same as that of the collection and delivery system 201 according to the second embodiment, a redundant description thereof will be omitted, and the collection and delivery system 301 is configured to be capable of notifying rails that can house the package B in the collection and delivery shelf. As shown in FIG. 6, a processing apparatus 310 includes a fifth acquisition unit 311 which acquires usage state information of the rails 33 of the first collection and delivery shelf 210 and the rails 51 of the second collection and delivery shelf 220 based on insertion and removal information of the tray 2. Here, the usage states of the rails 33 of the first collection and delivery shelf 210 and the rails 51 of the second collection and delivery shelf 220 indicate, for example, whether or not the rails 33 and 51 support the tray 2.

Further, for example, in a case where the worker P1 houses the package B in the first collection and delivery shelf 210, when the worker P1 reads the identification information of the tray 2 and the identification information of the package B through the first mobile terminal 4 and sets the usage mode of the first collection and delivery shelf 210 to a delivery mode, the control unit 312 of the processing apparatus 310 turns on the lighting units 211 of the rails 33 capable of supporting the tray 2 on which the package B is placed based on information indicating the usage mode set in the first collection and delivery shelf 210, the usage state information of the rails 33 of the first collection and delivery shelf 210, and height information included in the identification information of the package B associated with the identification information of the tray 2.

Further, for example, in a case where the requester P2 houses the package B in the second collection and delivery shelf 220, when the requester P2 reads the identification information of the tray 2 and the identification information of the package B through the second mobile terminal 6 and sets the usage mode of the second collection and delivery shelf 220 to a collection mode, the control unit 312 of the processing apparatus 310 turns on the lighting units 221 of the rails 51 capable of supporting the tray 2 on which the package B is placed based on information indicating the usage mode set in the second collection and delivery shelf 220, the usage state information of the rails 51 of the second collection and delivery shelf 220, and height information included in the identification information of the package B associated with the identification information of the tray 2.

At this time, the control unit 312 of the processing apparatus 310 can recognize the internal state of the first collection and delivery shelf 210 or the second collection and delivery shelf 220 based on, for example, the identification information of the rails 33 and 51 associated with identification information of another tray 2 housed in the first collection and delivery shelf 210 or the second collection and delivery shelf 220, and height information included in identification information of the package B placed on the other tray 2, and can recognize the rails 33 and 51 capable of supporting the tray 2 on which the package B is placed based on the above internal state.

Thus, the collection and delivery system 301 and the processing apparatus 310 according to this embodiment can notify the worker P1 and the requester P2 about the rails 33 and 51 that can house the package B. Therefore, the collection and delivery efficiency of the package B of the worker P1 and the requester P2 can be improved.

The present disclosure is not limited to the above-described embodiments and can be changed as appropriate without departing from the scope and spirit of the present disclosure.

For example, in the above-described embodiments, the robot 7 collects and delivers the package B, but the worker P1 may collect and deliver the package B.

For example, in the above-described embodiments, the worker P1 reads and inputs various kinds of information through the first mobile terminal 4, but the worker P1 may read and input various kinds of information through an input unit or the like provided in the first collection and delivery shelf. Similarly, in the above-described embodiments, the requester P2 reads and inputs various kinds of information through the second mobile terminal 6, but the requester P2 may read and input various kinds of information through an input unit or the like provided in the second collection and delivery shelf. In short, devices for reading and inputting various kinds of information are not limited.

For example, some or all of the above-described processes may be performed by a computer program. That is, a control computer comprising the processing apparatus may execute the program, thereby performing the control of the above processing apparatus.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A processing apparatus used for collecting a package from a shelf and delivering a package to the shelf by using a tray, the processing apparatus comprising:
a first acquisition unit configured to acquire latest usage state information of the tray including collection and delivery information of the tray;
a second acquisition unit configured to acquire position information of the tray;
a third acquisition unit configured to acquire identification information of the tray which is read by a reading unit provided for each of support units capable of supporting the tray in the shelf and stored in a tag provided in the tray; and
an update unit configured to update the usage state information of the tray and the position information of the tray associated with the identification information of the tray based on the latest usage state information of the tray, the position information of the tray, and the identification information of the tray.

2. The processing apparatus according to claim 1, comprising a fourth acquisition unit configured to acquire information indicating usage modes of the tray including a collection mode of the tray and a delivery mode of the tray set in the shelf,
wherein in a case where the third acquisition unit acquires the identification information of the tray when the support units of the shelf support the tray in the usage mode set in the shelf, the first acquisition unit acquires the latest usage state information of the tray in accordance with the usage mode set in the shelf.

3. The processing apparatus according to claim 2, comprising a control unit configured to control a lighting unit provided for each of the support units in the shelf,
wherein the control unit controls the lighting units in accordance with the usage mode set in the shelf.

4. The processing apparatus according to claim 3, wherein
when the usage mode set in the shelf is the collection mode of the tray, the control unit turns on the lighting units of the support units supporting at least one of the tray on which a package to be collected is placed or the tray on which a package to be collected is to be placed, and
when the usage mode set in the shelf is the delivery mode of the tray, the control unit turns on the lighting units of the support units supporting at least one of the tray on which a package to be delivered is placed or the tray on which a package to be delivered is to be placed.

5. The processing apparatus according to claim 3, comprising a fifth acquisition unit configured to acquire usage state information of the support units of the shelf,
wherein the control unit turns on the lighting units of the support units capable of supporting the tray on which the package to be collected is placed or the lighting units of the support units capable of supporting the tray on which the package to be delivered is placed based on information indicating the usage mode set in the shelf, the usage state information of the support units of the shelf, and identification information of the package to be placed on the tray associated with the identification information of the tray including height information of the package.
